(19) United States
(12) Patent Application Publication
(10) Pub. No.: US 2024/0012101 A1
(43) Pub. Date: Jan. 11, 2024

(54) ASYMMETRIC WIDE-ANGLE RADAR MODULE

(71) Applicant: ATCODI CO., LTD, Seoul (KR)

(72) Inventor: Jeong Pyo KIM, Suwon-si (KR)

(21) Appl. No.: 18/037,387

(22) PCT Filed: Nov. 19, 2020
(86) PCT No.: PCT/KR2020/016321

§ 371 Date: May 17, 2023

(30) Foreign Application Priority Data
Nov. 18, 2020 (KR) 10-2020-0154425

(51) Int. Cl. G01S 7/03; G01S 13/44; H01Q 21/00

(52) U.S. Cl. CPC G01S 7/032; G01S 13/4463; H01Q 21/0075; G01S 13/931

(57) ABSTRACT

An asymmetric wide-angle radar module according to an embodiment of the present invention includes: a first antenna unit with M (M: a positive integer) antenna structures of a first array in each of which L (L: a positive integer) antennas of the first array including A (A: a positive integer) radiating elements are arranged side by side: a second antenna unit with N (N: a positive integer) second array antennas comprising B (B: a positive integer) radiating elements; M first feed units supplying a feed signal to the first antenna unit; N second feed units supplying, a feed signal to the second antenna unit; and M first feed, lines connecting between the first feed unit and the one end of the first array antenna structure in the asymmetric wide-angle radar module.

### TECHNICAL FIELD

The present invention relates to an asymmetric wide-angle radar module. More specifically, it relates to an asymmetric wide-angle radar module that is mounted on an autonomous driving vehicle and can be used for various purposes.

### BACKGROUND OF THE INVENTION

Autonomous driving vehicles refer to the vehicles that can drive on their own without direct manipulation by a driver. Now, research and development are actively underway to realize the level 5 autonomous driving that is completely autonomous.

Such self-driving can only be achieved thanks to various sensors mounted on the vehicle, the ECU of which can make the autonomous driving by controlling various parts based on the sensing data of the sensors.

The radar is a representative one of the sensors that enable the autonomous driving. It emits strong electromagnetic waves, which collide with a specific object and return to the radar. The radar receives the returning echoes to detect the position of the object, moving speed, etc. The radars for self-driving vehicles can be classified into LRR (Long Range Radar), which detects long distances, MRR (Middle Range Radar), which detects medium distances, and SRR (Short Range Radar), which detects short distances, depending on the driving condition of the vehicle.

These radars are relatively expensive, and have different usage in general according to the driving condition of the vehicle. It is very difficult to develop an integrated radar module because the direction and distance to be detected through the radar are different. Therefore, the price of the autonomous driving vehicle gets very high because it needs to individually mount all the radars suitable for the purpose.

Furthermore, in order to implement level 5 autonomous driving, the radars as many as possible should be mounted in the vehicle. As it is difficult to provide a separate space for mounting multiple radars in the limited interior space of a vehicle, it inevitably causes lots of time and effort in designing the vehicle, which also causes a price increase.

Furthermore, recent radars are required to equip other functions in addition to conventional generalized functions such as BSD (Blind Spot Detection) function that detects a blind spot, RCTA (Rear Cross Traffic Alert) function that detects another vehicle approaching from the rear of the vehicle, and the LCA (Lane Change Assist) function that detects whether another vehicle is following in the next lane when the driver is changing the lane to it. To these ends, the radars need to have asymmetric and wide-angle characteristics because they have to detect a wide area as far as possible with one-time sensing.

The present invention is about to develop a new and advanced radar module that can minimize the number of radar mountings by performing a plurality of functions at once while preventing the price increase of autonomous driving vehicles, and can also implement asymmetric and wide-angle characteristics.

### DISCLOSURE OF THE INVENTION

### Technical Problems

A technical task to be achieved by the present invention is to provide an asymmetric wide-angle radar module capable of minimizing the number of mounted radars by performing a plurality of functions through one radar module.

Another technical task to be achieved by the present invention is to provide an asymmetric wide-angle radar module that can prevent the price increase of the autonomous driving vehicle by performing a plurality of functions through one radar module.

And another technical task to be achieved by the present invention is to provide an asymmetric wide-angle radar module that can be widely used for BSD function, RCTA function, and LCA function to sense the area as far and as wide with one sensing by implementing the asymmetric and wide-angle characteristics.

The technical tasks of the present invention are not limited to the tasks mentioned above, and other technical tasks not mentioned here will be clearly understood by those skilled in the field from the descriptions below.

### Technical Solutions

An asymmetric wide-angle radar module according to an embodiment of the present invention for achieving the above technical tasks is composed of follows: the first antenna unit with M (M: a positive integer) antenna structures of the first array in each of which L(L: a positive integer) antennas of the first array comprising A (A: a positive integer) radiating elements are arranged side by side; the second antenna unit with N (N: a positive integer) second array antennas comprising B (B: a positive integer) radiating elements; M first feed units supplying a feed signal to the first antenna unit; N second feed units supplying a feed signal to the second antenna unit; and M first feed lines connecting between the first feed unit and the one end of the first array antenna structure in the asymmetric wide-angle radar module.

According to an embodiment, the spacing between the N second array antennas may be 0.5λ.

According to an embodiment, the spacing between the M first array antenna structures may be N*0.5λ or less.

According to an embodiment, the spacing between the L first array antennas may be 0.5˜1.0λ.

According to an embodiment, the first feed line may include the 1-1 feed line on the left of the branch point located at the other end of first feed unit and the 1-2 feed line on the right of the branch point.

According to an embodiment, when the lengths of the 1-1 and 1-2 feed lines are the same, the phase of the feed signal supplied to the 1-1 feed line and that to the 1-2 feed line may be the same.

According to an embodiment, when the lengths of the 1-1 feed line and 1-2 feed line are different and the L value is 2, the phase of the feed signal supplied to the 1-1 feed line and that to the 1-2 feed line may have a phase difference corresponding to the difference in length between the 1-1 feed line and 1-2 feed line.

According to an embodiment, when L is 3 or more, when only one first array antenna is placed at the other end of the 1-1 feed line, when the 1-2 feed line comprises the 1-2-1 feed line to the first array antenna placed nearest to the branch point on the right, and when the lengths of 1-1 feed line and 1-2-1 feed line are different, the phase of the feed signal supplied to the 1-1 feed line and that to the 1-2-1 feed line may have a phase difference corresponding to the difference in length between the 1-1 feed line and 1-2-1 feed line.

According to an embodiment, when the 1-2 feed line further includes K-1 (K: a positive integer) 1-2-2 feed lines between K first array antennas that are located nearest to the branch point on the right, and when the lengths of the 1-1 feed lines and the 1-2-1 feed lines are different, the length of each of the K-1 1-2-2 feed lines may be the sum of λ and half of the length difference between the 1-1 feed line and the 1-2-1 feed line.

According to an embodiment, when the thickness of the first length of the 1-1 feed line in the direction to the branch point is the same as that of the 1-2 feed line in the direction to the branch point, the power level of the feed signal supplied to the 1-1 feed line and that to the 1-2 feed line may be the same.

According to an embodiment, when the thickness of the first length of the 1-1 feed lines in the direction to the branch point is different from that of the first length of the 1-2 feed lines in the direction to the branch point, and when the L is 2, the power level of the feed signal supplied to the 1-1 feed line and that to the 1-2 feed line may be different each other.

According to an embodiment, the impedance matching may be achieved by adjusting the thickness of the first length in the direction to the branch point among the first power feed unit.

According to an embodiment, when L is 3 or more, when only one first array antenna is placed at the other end of the 1-1 feed line, when the 1-2 feed line includes the 1-2-1 feed lines to the first array antennas that are located nearest to the branch point on the right, and when the thickness of the first length of the 1-1 feed lines in the direction to the branch point is different from that of the first length of the 1-2-1 feed lines in the direction to the branch point, the power level of the feed signal supplied to the 1-1 feed line and that of the feed signal supplied to the 1-2-1 feed line may be different.

According to an embodiment, the 1-2 feed line may further include K-1 (K: a positive integer) 1-2-2 feed lines between K first array antennas that are located nearest to the branch point on the right, and the power level of the feed signal supplied to each of the K-1 1-2-2 feed lines may be determined using the thickness of the feed line connected to the input terminal of the first array antenna placed in the direction to the branch point based on the corresponding 1-2-2 feed lines and the thickness of the first length placed on the right of the feed line connected to the input end of the first array antenna among the corresponding 1-2-2 feed lines.

According to an embodiment, the first length may be λ/4.

According to an embodiment, when the first antenna unit is an antenna unit of transmission channel, the second antenna unit may be an antenna unit of reception channel.

According to an embodiment, when the first antenna unit is an antenna unit of reception channel, the second antenna unit may be an antenna unit of transmission channel.

### Advantageous Effects

According to the present invention as described above, the phase difference of the feed signals provided to the L first array antennas can be freely controlled by adjusting the difference in length between the 1-1 feed line to provide the feed signal to the first array antenna placed on the left of the branch point and the 1-2 feed line to provide the feed signal to the first array antenna placed on the right of the branch point, and also adjusting the difference in length with the 1-2-1 feed line and the length of the 1-2-2 feed line. In this way, this invention has the characteristics of the asymmetric radiation pattern that can be effectively implemented according to the intention of the designer.

In addition, it can freely control the power level of the feed signals provided to the L first array antennas by adjusting the thickness of the first length in the direction to the branch point(P) on the 1-1 feed line to provide the feed signal to the first array antenna placed on the left side and the thickness of the first length in the direction to the branch point on the 1-2 feed line to provide the feed signal to the first array antenna disposed on the right side of the branch point; by adjusting the thickness of the 1-2-1 feed line included in the 1-2 feed line and the thickness of the feed line connected to the input end of the first array antenna placed in the direction to the branch point based on the 1-2-2 feed line and the thickness of the first length placed on the right side of the feed line connected to the input end of the first array antenna among the corresponding 1-2-2 feed lines. In this way, this invention has the characteristics of the asymmetric radiation pattern that can be effectively implemented according to the intention of the designer.

And, by realizing an asymmetric wide-angle radiation pattern, it can perform a plurality of functions through one radar module, thereby minimizing the number of mounting units and preventing the price increase of an autonomous driving vehicle.

In addition, by realizing an asymmetric wide-angle radiation pattern, it can have an effect to be widely used for the BSD function, which senses the area as wide as possible with one-time sensing, the RCTA function, and the LCA function.

The effects of the present invention are not limited to those mentioned above, and other effects not mentioned will be clearly understood by the ordinary technicians in the field from the descriptions below.

### BRIEF DESCRIPTION OF THE DRAWINGS

FIG. 1 is a diagram illustrating a configuration of the asymmetric wide-angle radar module according to an embodiment of the present invention.

FIG. 2 is an exemplary diagram showing a first antenna unit.

FIG. 3 is a diagram showing a radiation pattern in the case that the first antenna unit is 10 by 2(10×2).

FIG. 4 is a diagram showing a second antenna unit.

FIG. 5 is a diagram illustrating the radiation pattern in the case that the second antenna unit is 10×1.

FIGS. 6 to 8 are the exemplary illustrations in which a phase difference of the power feed signal is adjusted.

FIGS. 9 to 11 are the exemplary illustrations in which the power level of a feed signal is adjusted.

FIG. 12 is a diagram illustrating a radiation pattern of the asymmetric wide-angle radar module itself according to an embodiment of the present invention.

### DETAILED DESCRIPTION OF THE INVENTION

Hereinafter, some preferred embodiments of the present invention will be described in detail with reference to the accompanying drawings. Advantages and features of the present invention, as well as methods for achieving them, will get clear with the embodiments described below and the accompanying drawings. However, the present invention is not limited to the embodiments disclosed below, but may be implemented in various different forms. The present embodiments just make the disclosure of the present invention complete, and inform those with common knowledge in the relevant field of the complete range of present invention. The present invention is only defined by the scope of the claims. The same reference numbers are used for the same elements throughout the specification.

Unless otherwise defined, all terms (including technical and scientific terms) used in this specification may have meanings commonly understood by ordinary technicians in the field to which the present invention belongs. In addition, the terms defined in commonly used dictionaries are not interpreted oddly or excessively unless specifically defined as such. The terms in this specification are for describing embodiments and are not intended to limit the present invention. In this specification, singular forms may also include plural forms unless specifically stated otherwise in the phrase.

The term “comprises” and/or “comprising” in this specification does not exclude the existence or additions of one or more components, steps, operations, and/or elements other than the stated component, step, operation, and/or element.

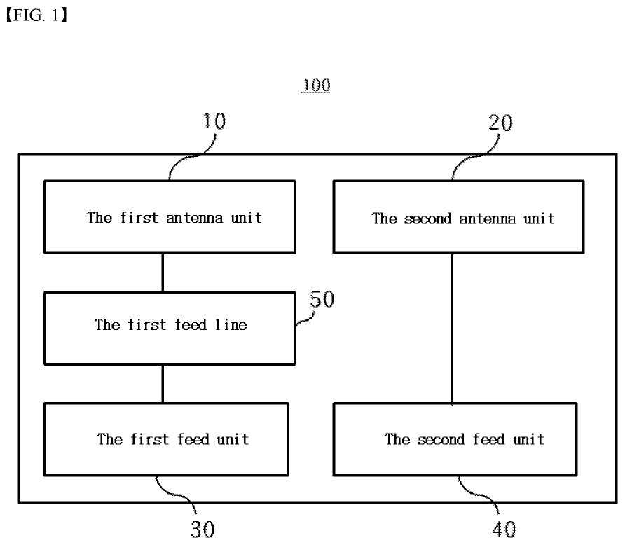

FIG. 1 is a diagram showing the configuration of the asymmetric wide-angle radar module (100) according to an embodiment of the present invention.

The multi-mode radar module (100) according to an embodiment of the present invention comprises the first antenna unit (10), the second antenna unit (20), the first feed unit (30), a second feed unit (40) and the first feed line (50), in addition to which the module may surely comprise typical components required in achieving the object of the present invention.

The first antenna unit (10) comprises M (M: a positive integer) first array antenna structures (I) in which L (L: a positive integer) first array antennas (15) with A (A: a positive integer) radiating elements are arranged side by side. M (M is a positive integer) are arranged.

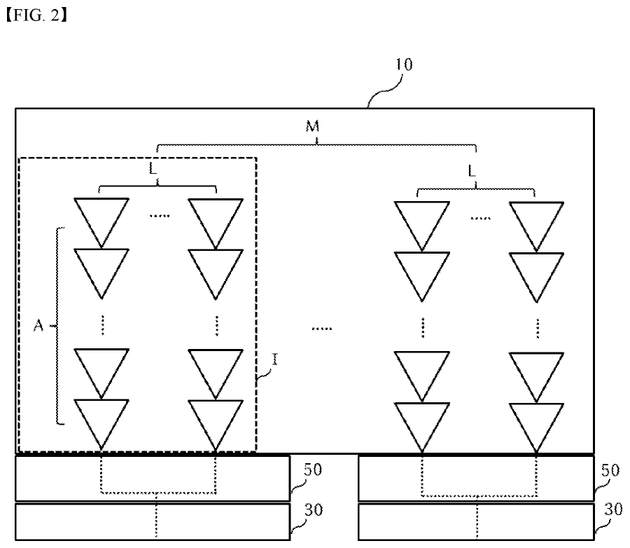

In FIG. 2 showing an example of the first antenna unit (10), one first array antenna structure (I) itself is a A×L array antenna (A radiating element in the elevation direction and L radiating elements in the azimuth direction). The fact that L first array antenna elements (15) are arranged side by side means that the individual first array elements (15) are arranged in parallel with each other. More specifically, the spacing between each of the first array elements (15) arranged parallel is 0.5˜1.0λ, which is an array spacing in the azimuth direction.

The first antenna unit (10) can be seen as a structure in which an array antenna element of A×1 is arranged as many as L in the azimuth direction. Therefore, when feeding L array elements of A×1 in the azimuth direction, the maximum aiming direction may be controlled through the phase difference of the feed signals, and the flatness of the radiation pattern be controlled by adjusting the power level of the feed signals.

On the other hand, in relation to the arrangement of the first array antenna structures (I), the spacing between each of the M first array antenna structures (I) is related to N (N: a positive integer), which is the number of second array antennas to be described later. More specifically, the spacing is N*0.5λ or less, which is to operate it as a MIMO radar system together with the second antenna unit (20) to be described later.

The first array antenna structure (I) has no special or independent meaning in its name but was arbitrarily coined in this specification to distinguish a configuration, in which L first array antennas comprising A radiating elements are arranged side by side, from other configurations. It can be regarded just as a set of L first array antennas, one end of which is connected to the first feed line (50) to be described later.

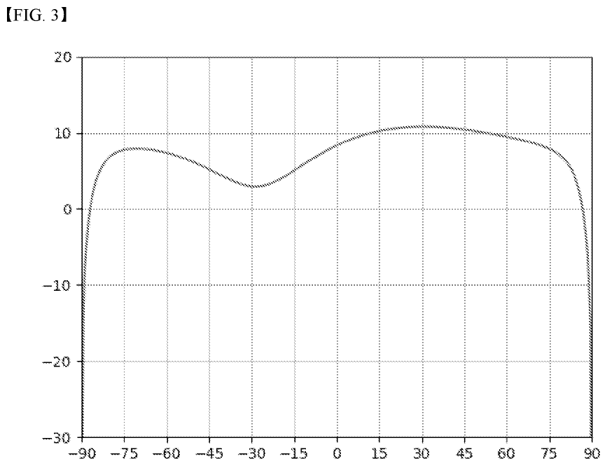

FIG. 3 exemplarily shows a radiation pattern with the first antenna unit (10) of array, where the left radiation pattern and the right radiation pattern are different from each other with respect to 0°, and at the same time, the maximum aiming direction is clearly asymmetric. The principle of this radiation pattern can be explained based on two A×1 array antennas as follows: the maximum aiming direction is the straight forward (0°) when the phase difference of the feed signals is 0°; but it becomes ±90° with the phase difference of 180°; so the maximum aiming direction comes to be between 0° and 90° because the phase difference must have a value between 0° and 180°.

Based on this principle, the asymmetric wide-angle radar module (100) according to an embodiment of the present invention adjusts the phase difference of the feed signals supplied to the first antenna unit (10) so as to freely control the maximum directing direction on the asymmetric radiation pattern as the designer has intended, which will be described later.

In the second antenna unit (20), N second array antennas (25) comprising B (B: a positive integer) radiating elements.

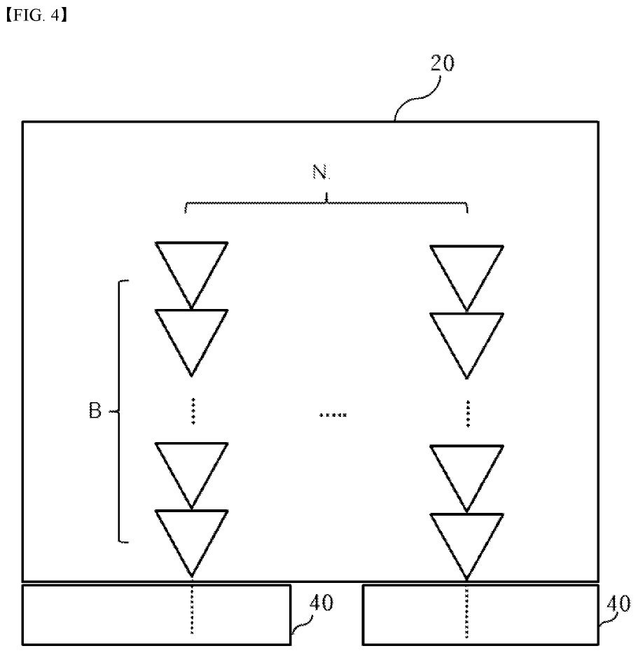

FIG. 4 shows an example of the second antenna unit (20), which does not require a second array antenna structure, unlike the first antenna unit (10), because the second antenna unit (20) has N second array antennas arranged independently to each other. Therefore, it can be regarded as a B×1 array antenna, where the number B can be the same as A.

The beam width of the second antenna unit (20) in the elevation direction can change according to B, which is the number of radiating elements arranged in the elevation direction, but the beam width in the azimuth direction can be formed constant regardless of B because it has just one radiating element in the azimuth direction. Therefore, it has a structure suitable for displaying a wide-angle radiation pattern.

Meanwhile, the spacing between each of the N second array antennas may be because the detectable angle becomes the widest as 180° when the second array antennas are arranged at 0.5λ spacing according to the radar and antenna theory. And the wide-angle effect can be maximized if the second array antennas in the second antenna unit (20) have a symmetrical shape by adjusting N and, at the same time, have a beam width of 150° or more.

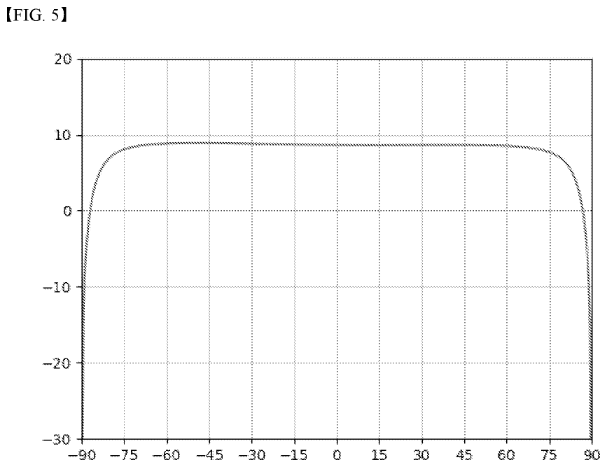

FIG. 5 exemplarily shows a radiation pattern when the second antenna unit (20) is a 10×1 array, where it mostly shows a relatively uniform and wide-angle radiation pattern between −90° and +90°.

Now, let's go back to the description of FIG. 2.

The first feed unit (30) supplies the feed signal to the first antenna unit (10), which comprises the M first array antenna structures (I). The first feed unit (30) is also arranged as many as M to supply the feed signal to each of the first array antenna structures (I).

The second feed unit (40) supplies the feed signal to the second antenna unit (20), which comprises the N second array antennas. The second feed unit (40) is also arranged as many as N to supply the feed signal to each of the second array antennas.

Such first feed unit (30) and second feed unit (40) can receive the power from the main processor (not illustrated) or the control unit (not illustrated), which is one of the typical components required for achieving the purpose of the asymmetric wide-angle radar module (100) according to an embodiment of the present invention. However, since it corresponds to a known configuration in the radar module field, a detailed description thereof is omitted.

The first feed line (50) is connected to the first feed unit (30), more specifically, to the branch point(P) placed at the other end of the first feed unit (30), and to one end of the first array antenna structure (I). Since the first antenna unit (10) comprises M first array antenna structures (I), the first feed line (50) is also arranged as many as M to provide the first array antenna structures (I) with the feed signal supplied by the first feed unit (30).

Meanwhile, the first feed line (50) comprises the 1-1 feed line (50-1) placed on the left side of the branch point(P) at the other end of the first feed unit (30) and the 1-2 feeding line (50-2) placed on the right side of the branch point(P) at the other end of the first feed unit (30). The phase difference of feed signals supplied to the L first array antennas can be controlled by adjusting the lengths of the 1-1 feed line (50-1) and the 1-2 feed line (50-2), And the power level of the feed signal supplied to the L first array antennas can be controlled by adjusting the thickness of the 1-1 feed line (50-1) and the 1-2 feed line (50-2). Through these, the first antenna unit (10) can have characteristics of an asymmetric radiation pattern. Hereinafter, the phase difference adjustment of the feed signal will be described in detail.

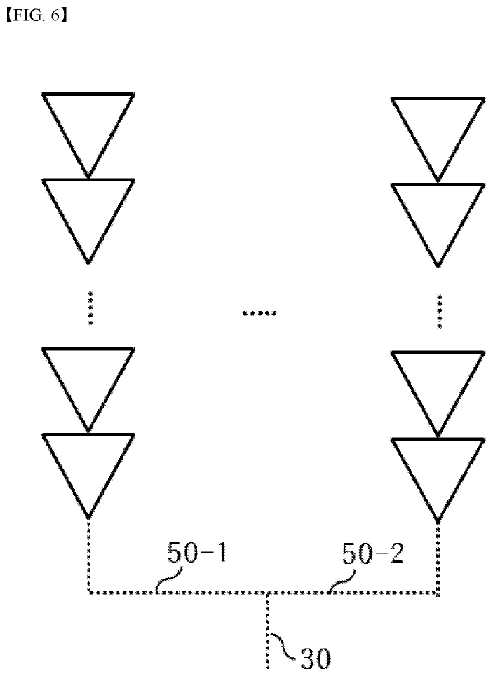

As mentioned above, the phase difference of the feed signals supplied to the L first array antennas can be controlled by adjusting the lengths of the 1-1 feed line (50-1) and the 1-2 feed line (50-2). As shown in FIG. 6, when the lengths of the 1-1 feed line (50-1) and the 1-2 feed line (50-2) are the same, the phases of the feed signals supplied to the 1-1 feed line (50-1) and to the 1-2 feed line (50-2) become the same. If the lengths of the 1-1 feed line (50-1) and the 1-2 feed line (50-2) are the same, the phases of the feed signals supplied to the 1-1 feed line (50-1) and to the 1-2 feed line (50-2) become the same regardless of the number L of the first array antennas. Therefore, all the L first array antennas can be supplied with the feed signals of same phase.

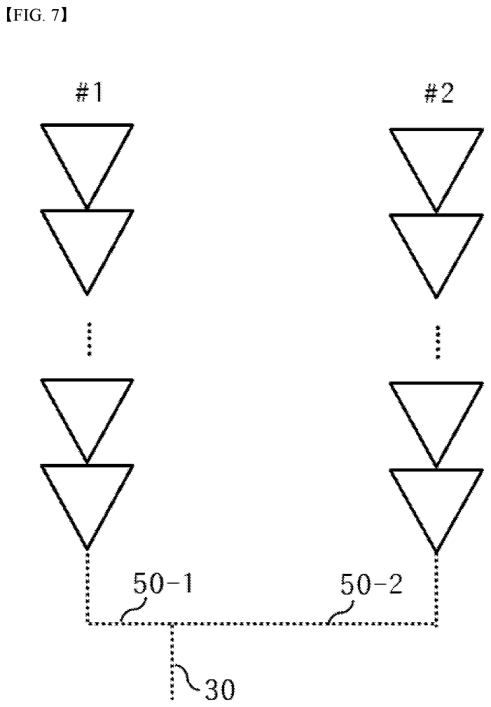

Meanwhile, as illustrated in FIG. 7, if the lengths of the 1-1 feed line (50-1) and the 1-2 feed line (50-2) are different and the number L of first array antennas is 2, the phases of the feed signals supplied to the 1-1 feed line (50-1) and the 1-2 feed line (50-2) become different, having the phase difference corresponding to the length difference between the 1-1 feed line (50-1) and the 1-2 feed line (50-2).

In the drawing, when the first feed unit (30) moves from the center to one direction, there happens a phase difference corresponding to twice the distance moved. For example, if a phase difference of 110° needs to be generated, the first feed unit (30) moves from the center to one direction by a distance that the phase change on the feeding line is 55° (55/360*λ). Then, the phase of the feed signal decreases by 55° at the 1-1 feed line (50-1) where #1 is placed, and increases by 55° at the 1-2 feed line (50-2) where #2 is placed, resulting in the phase difference of 110°.

Here, the distance that the first feed unit (30) moves from the center in one direction can be represented by the length difference between the 1-1 feed line (50-1) and the 1-2 feed line (50-2). For example, when the first feed unit (30) is located at the center and the lengths of the 1-1 feed line (50-1) and the 1-2 feed line (50-2) are 2λ, if the first feed unit (30) moves by 1λ to the #1 direction, the phase difference is generated by 2λ, corresponding to twice of this. In this case, the length of the 1-1 feed line (50-1) becomes 1λ and the length of the 1-2 feed line (50-2) becomes 3λ, resulting the length difference between the 1-1 feed line (50-1) and the 1-2 feed line (50-2) to be 2λ. Thus, the distance the first feed unit (30) moves from the center in one direction becomes the half of the length difference between the 1-1 feed line (50-1) and the 1-2 feed line (50-2); in other words, twice the distance the first feed unit (30) moves from the center in one direction becomes the same as the length difference between the 1-1 feed line (50-1) and the 1-2 feed line (50-2). Accordingly, when the lengths of the 1-1 feed line (50-1) and the 1-2 feed line (50-2) are different, there happens a phase difference corresponding to the length difference between them.

This reflects the situation that the lengths of the 1-1 feed line (50-1) and the 1-2 feed line (50-2), which were the same, becomes different if the first feed unit (30) moves in one direction from the center. As described above, it can also be said that there happens a phase difference corresponding to twice the distance moved by the first feed unit (30).

Now, let's think about the case where L is 3 or more.

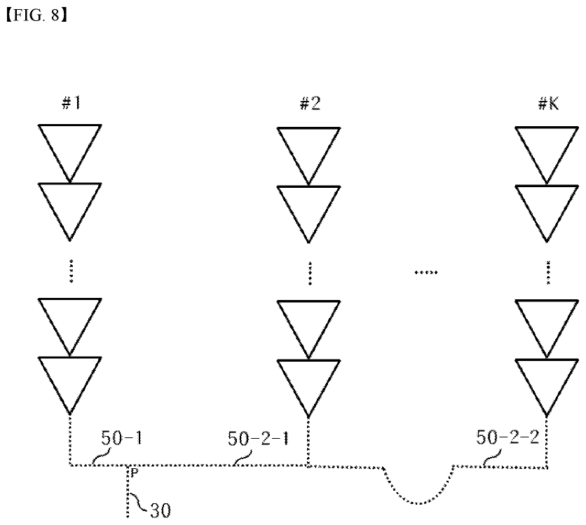

According to an embodiment in FIG. 8, the number L of the first array antennas is 3 or more, only one first array antenna is arranged at the other end of the 1-1 feed line (50-1), and the 1-2 feed line (50-2) comprises the 1-2-1 feed line (50-2-1) supplying the power to the first array antenna which is arranged closest to the right side of the branch point(P). When the lengths of the 1-1 feed line (50-1) and the 1-2-1 feed line (50-2-1) are different, the feed signals supplied to the 1-1 feed line (50-1) and to the 1-2-1 feed line (50-2-1) come to have the phase difference corresponding to the length difference between the 1-1 feed line (50-1) and the 1-2-1 feed line (50-2-1).

FIG. 8 differs from FIG. 7 in that two or more first array antennas are arranged on the 1-2 feed line (50-2) in FIG. 8. Among the first array antennas arranged on the 1-2 feed line (50-2), the first array antenna placed closest to the right side of the branch point(P) along with the 1-2-1 feed line (50-2-1), the 1-1 feed line (50-1) and one first array antenna connected to it can be considered to have the same relations as in FIG. 7. Therefore, as in FIG. 7, if the 1-1 feed line (50-1) and the 1-2-1 feed line (50-2-1) have different lengths, the feed signals supplied to the 1-1 feed line (50-1) and to the 1-2-1 feed line (50-2-1) come to have the phase difference corresponding to the length difference between the 1-1 feed line (50-1) and the 1-2-1 feed line (50-2-1). Detailed explanations are omitted to prevent redundant description.

In this case, it becomes important how to arrange the lengths of the 1-2 feed line (50-2) and the other K-1 (K: a positive integer) 1-2-2 feed lines (50-2-2) lying between the nearest first array antenna on the right of branch point(P) and the K first array antennas. It is because the phase difference between feed signals supplied to all first array antennas should be the same.

When the lengths of the 1-1 feed line (50-1) and the 1-2-1 feed line (50-2-1) are different, each length of K-1 1-2-2 feed lines (50-2-2) should be the sum of λ and half of the length difference between the 1-1 feed line (50-1) and the 1-2-1 feed line (50-2-1) so as to generate the same phase difference between all pairs of #2 and #3, #3 and #4, and then #K−1 and #K as the phase difference between #1 and #2.As described above, the length difference between the 1-1 feed line (50-1) and the 1-2-1 feed line (50-2-1) is twice the distance traveled by the first feed unit (30), and the distance traveled by the first feed unit (30) to generate the phase difference is the half of length difference between the 1-1 feed line (50-1) and the 1-2-1 feed line (50-2-1). Therefore, only when each length of K-1 1-2-2 feed lines (50-2-2) should include the half of the length difference between the same 1-1 feed line (50-1) and the 1-2-1 feed line (50-2-1) as such, the phase difference between #1 and #2 can also occur individually in #2 and #3, #3 and #4, and thereafter #K-1 and #K.

Meanwhile, the reason why each length of K-1 1-2-2 feed lines (50-2-2) should include λ in addition to the half of the length difference between the 1-1 feed line (50-1) and the 1-2-1 feed line (50-2-1) is that λ represents 360°, giving no effects on the phase and allows the physical space between the first array antennas in the actual implementation.

Up to now, the adjustment of the phase difference between the feed signals has been described so that the first antenna unit (10) can have the characteristics of an asymmetric radiation pattern in the asymmetric wide-angle radar module (100) according to an embodiment of the present invention. According to the present invention, the phase difference of feed signals supplied to the L first array antennas can be controlled by adjusting the length difference between the 1-1 feed line (50-1) which supplies the feed signal to the first array antenna arranged on the left of the branch point(P) and the 1-2 feed line (50-2) which supplies the feed signal to the first array antenna arranged on the right, or moreover the 1-2-1 feed line (50-2-1) included in the 1-2 feed line (50-2), and the length of the 1-2-2 feed line (50-2-2). In this way, the characteristics of an asymmetric radiation pattern can be effectively implemented as intended by the designer. From now on, the adjustment of the power level that can implement the characteristics of the asymmetric radiation pattern together with the phase difference of the feed signal will be described.

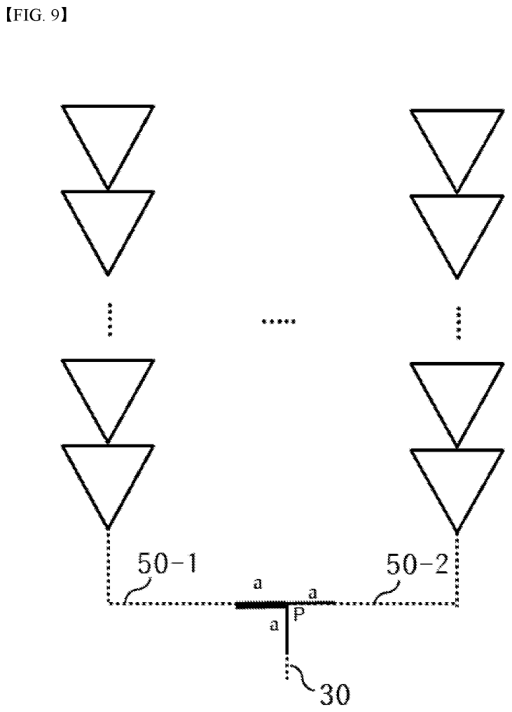

As mentioned above, the power level of the feed signal supplied to the L first array antennas can be controlled by adjusting the thickness of the 1-1 feed line (50-1) and the 1-2 feed line (50-2). As shown in FIG. 9, when the thickness of the first length (a) in the direction to the branch point(P) on the 1-1 feed line (50-1) is the same as the thickness of the first length (a) in the direction to the branch point(P) on the 1-2 feed line (50-2), the power level of the feed signal supplied to the 1-1 feed line (50-1) becomes the same as that of the feed signal supplied to the 1-2 feed line (50-2). If the thicknesses of the 1-1 feed line (50-1) and the first length (a) in the direction to the branch point(P) on the 1-2 feed line (50-2) are the same, the power levels of the feed signals supplied to the 1-1 feed line (50-1) and to the 1-2 feed line (50-2) become the same regardless of the number L of the first array antennas. Therefore, all the L first array antennas can be supplied with the feed signals of same power level.

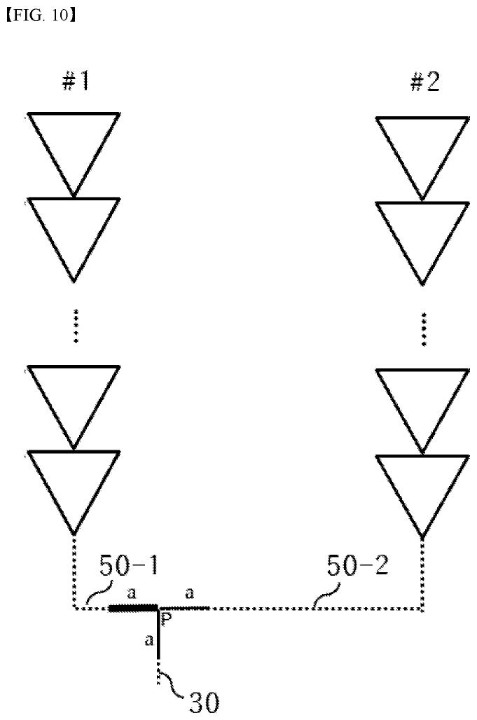

On the other hand, as shown in FIG. 10, when the thickness of the first length (a) in the direction to the branch point(P) on the 1-1 feed line (50-1) is different from that of the first length (a) in the direction to the branch point(P) on the 1-2 feed line (50-2) and the number L of the first array antenna is 2, the power levels of the feed signals supplied to the 1-1 feed line (50-1) and to the 1-2 feed line (50-2) become different from each other.

Herein, it is rather difficult to express the difference in the power levels, unlike the phase difference of the feed signals, with the constant criteria, such as the thickness difference between the first length (a) in the direction to the branch point(P) on the 1-1 feed line (50-1) and the first length (a) in the direction to the branch point(P) on the 1-2 feed line (50-2). It is because to adjust the thickness of the first length (a) in the direction to the branch point(P) on the 1-1 feed line (50-1) and thickness of the first length (a) in the direction to the branch point(P) on the 1-2 feed line (50-2) in order to supply the feed signals of different power levels to two first array antennas is to adjust their impedance ratio. And furthermore, it becomes to additionally adjust the thickness of the first length (a) in the direction to the branch point(P) on the first feed unit (30) to achieve the impedance matching.

To put it simply, if the first length (a) gets thicker, the impedance gets lower. In this case, the power level of the feed signal supplied to the corresponding part gets higher. On the other, if the first length (a) gets thinner, the impedance increases, and then the power level of the feed signal supplied to the corresponding part gets lower. It is to utilize the phenomenon in which power is distributed according to the impedance ratio.

Now, the case where L is 3 or more will be explained.

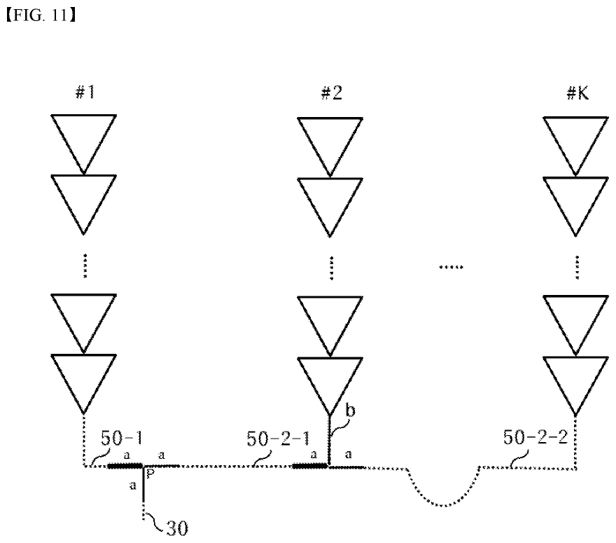

As illustrated in FIG. 11, the number L of the first array antennas is 3 or more, only one first array antenna is arranged at the other end of the 1-1 feed line (50-1), and the 1-2 feed line (50-2) comprises the 1-2-1 feed line (50-2-1) supplying the power to the first array antenna which is arranged closest to the right side of the branch point(P). And when the thickness of the first length (a) in the direction to the branch point(P) on the 1-1 feed line (50-1) is different from the thickness of the first length (a) in the direction to the branch point(P) on the 1-2-1 feed line (50-2), the power level of the feed signal onto the 1-1 feed line (50-1) becomes different from the power level of the feed signal onto the 1-2-1 feed line (50-2-1).

FIG. 11 differs from FIG. 10 in that two or more first array antennas are arranged on the 1-2 feed line (50-2) in FIG. 11. Among the first array antennas arranged on the 1-2 feed line (50-2), the first array antenna placed closest to the right side of the branch point(P) along with the 1-2-1 feed line (50-2-1), the 1-1 feed line (50-1) and one first array antenna connected to it can be considered to have the same relations as in FIG. 10. Therefore, as in FIG. 10, if the thickness of the first length (a) in the direction to the branch point(P) on the 1-1 feed line (50-1) is different from the thickness of the first length (a) in the direction to the branch point(P) on the 1-2-1 feed line (50-2), the feed signals supplied to the 1-1 feed line (50-1) and to the 1-2-1 feed line (50-2-1) come to have different power levels. Detailed explanations are omitted to prevent redundant description.

In this case, it becomes important how to determine the power levels of feed signals supplied to the 1-2 feed line (50-2) and the other K-1 (K: a positive integer) 1-2-2 feed lines (50-2-2) lying between the nearest first array antenna on the right of branch point(P) and the K first array antennas.

The power level of the feed signals supplied to each of the K-1 1-2-2 power supply lines (50-2-2) is determined using the thickness of the feed line (b) connected to the input end of first array antenna in the direction to the branch point(P) based on the relevant 1-2-2 feed line (50-2-2) and the thickness of the first length (a) placed on the right side of feed line connected to the input end of first array antenna on the relevant 1-2-2 feed line (50-2-2). Like the thickness of the first length (a) in the direction to the branch point(P) in the first feed unit (30), the thickness of the first length (a) on the left of the feed line connected to the input end of first array antenna on the relevant 1-2-2 feed line (50-2-2) is adjusted to achieve the impedance matching.

For ease of explanation, in the whole system, considering the antennas of #2 #K as one first antenna unit (10), the thickness of the first length (a) in the direction from #1 to the branch point(P) on the 1-1 feed line (50-1) and the thickness of the first length (a) in the direction to the branch point(P) on the 1-2-1 feed lines (50-2-1) are adjusted to control the power level of the feed signal; in the system comprising #2˜#K, considering the antennas of #3˜#K as one first antenna unit (10), the thickness of the feed line connected to the input end of #2 and the thickness of the first length lying on its right side are used to control the power level of the feed signal. By repeating this process, the power level of the feed signals supplied to the L first array antennas can be adjusted.

Meanwhile, the first length (a) in the above description may be λ/4, which is for impedance matching.

So far, the adjustment of the power level of the feed signal so that the first antenna unit (10) may have the characteristics of an asymmetric radiation pattern in the asymmetric wide-angle radar module (100) according to an embodiment of the present invention has been described. According to the present invention, the power level of the feed signal provided to the L first array antennas can be freely adjusted and thus the characteristics of the asymmetric radiation pattern can be effectively implemented as intended by the designer by adjusting the thickness of the first length (a) in the direction to the branch point(P) on the 1-1 feed line (50-1) providing the feed signal to the first array antenna placed on the left side of the branch point(P) and the thickness of the first length (a) in the direction to the branch point(P) on the 1-2 feed line (50-2) providing the feed signal to the first array antenna placed on the right and the right side, and furthermore, by adjusting the thickness of the 1-2-1 feed line (50-2-1) included in the 1-2 feed line (50-2) and of the feed line (b) connected to the input end of the first array antenna in the direction to the branch point(P) based on the 1-2-2 feed line (50-2-2) and the thickness of the first length (a) placed on the right side of the feed line connected to the input end of the first array antenna on the relevant 1-2-2 feed line (50-2-2).

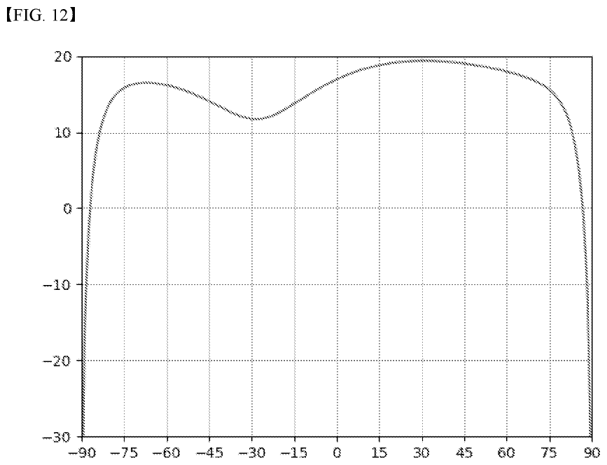

FIG. 12 is a diagram showing the radiation pattern of the asymmetric wide-angle radar module (100) itself according to an embodiment of the present invention, where the radiation pattern of the first antenna unit (10) in FIG. 3 and the radiation pattern of the second antenna unit (20) in FIG. 5 are integrated and, more specifically, the wide-angle characteristic is 150° or more. In this, since the asymmetric wide-angle radar module (100) itself according to an embodiment of the present invention presents an asymmetric wide-angle radiation pattern, it can perform a plurality of functions through one radar module, minimizing the number of mounting radars and thus preventing the price increase of autonomous driving vehicle. In addition, with its asymmetric wide-angle radiation pattern, it can be widely used for BSD function, RCTA function, and LCA function that need to detect the farthest and widest area with one-time sensing.

On the other hand, In the case of a general radar module, two antenna units are included: a transmission channel antenna unit and a reception channel antenna unit. In the embodiment of the present invention for the asymmetric wide-angle radar module (100) described so far, the first antenna unit (10) is the transmission channel antenna unit and the second antenna unit (20) is the reception channel antenna unit. Of course, the first antenna unit (10) may be the reception channel antenna unit, and the second antenna unit (20) be the transmission channel antenna unit. In this case, all the above descriptions on the first antenna unit (10), for example, on the adjustments of phase difference and power level of the feed signal in order to implement an asymmetric wide-angle radiation pattern may be applied to the second antenna unit (20) as it is.

Finally, another embodiment of the present invention may be an autonomous driving vehicle module (not illustrated), an autonomous driving vehicle system (not illustrated), and an autonomous driving vehicle (not illustrated) including an asymmetric wide-angle radar module (100). Furthermore, the manufacturing method and control method of the asymmetric wide-angle radar module (100) may also correspond to one of various embodiments of the present invention.

Up to now, the embodiments of the present invention have been described with reference to the accompanying drawings. But those who are skilled in the field related to the present invention would well understand that this invention can be implemented in other specific forms without changing its technical spirit or essential features. Therefore, the embodiments described above shall be understood just as illustrative in all respects and not definitive.

1. An asymmetric wide-angle radar module comprising:
a first antenna unit comprising M (M: a positive integer) first array antenna structures arranged side by side, each of which comprises L (L: a positive integer) first array antennas, each of which is composed of A (A: a positive integer) radiating elements;
a second antenna unit comprising N (N: a positive integer) second array antennas, each of which is composed of B (B: a positive integer) radiating elements;
M first feed units supplying the feed signal to the first antenna unit;
N second feed units supplying the feed signal to the second antenna unit; and
M first feed lines connecting to the first feed unit and the one end of the first array antenna structure.

2. The asymmetric wide-angle radar module according to claim 1, wherein the spacing of each of the N second array antennas is 0.5λ.

3. The asymmetric wide-angle radar module according to claim 1, wherein the spacing of each of the M first array antennas is N*0.5λ or lower.

4. The asymmetric wide-angle radar module according to claim 1, wherein the spacing between each of the L first array antennas is 0.5-1.0λ.

5. The asymmetric wide-angle radar module according to claim 1, wherein the first feed line comprises;
a 1-1 feed line placed on the left of the branch point at the other end of the first feed unit; and
a 1-2 feed line placed on the right side of the branch point at the other end of the first feed unit.

6. The asymmetric wide-angle radar module according to claim 5, wherein when the lengths of the 1-1 feed line and the 1-2 feed line are the same, the phases of the feed signals supplied to the 1-1 feed line and the 1-2 feed line become same.

7. The asymmetric wide-angle radar module according to claim 5, wherein when the lengths of the 1-1 feed line and the 1-2 feed line are different and L is 2, the feed signals supplied to the 1-1 feed line and the 1-2 feed line come to have a phase difference corresponding to the difference in lengths of the 1-1 feed line and the 1-2 feed line.

8. The asymmetric wide-angle radar module according to claim 5, wherein:
when L is 3 or more, and only one first array antenna is placed at the other end of the 1-1 feed line, and the 1-2 feed line comprises the 1-2-1 feed line lying between the branch point and the first array antenna placed closest to the branch point on its right; and
when the lengths of the 1-1 feed line and the 1-2-1 feed line are different, the feed signals supplied to the 1-1 feed line and the 1-2-1 feed line indicate a phase difference corresponding to the difference in lengths of the 1-1 feed line and the 1-2-1 feed line.

9. The asymmetric wide-angle radar module according to claim 8, wherein:
the 1-2 feeding line further comprises the K-1 1-2-2 feed lines lying between K (K: a positive integer) first array antennas disposed on the right of the first array antenna which is closest to the branch point, and
when the lengths of the 1-1 feed line and the 1-2-1 feed line are different, the lengths of each of the K-1 1-2-2 feed lines are the sum of λ and the half of the length differences between the 1-1 feed line and the 1-2-1 feed line.

10. The asymmetric wide-angle radar module according to claim 5, wherein when the thickness of the first length of the 1-1 feed line in the direction to the branch point is the same as the thickness of the first length of the 1-2 feed line in the direction to the branch point, the power level of the feed signal supplied to the 1-1 feed line becomes the same as that of the feed signal supplied to the 1-2 feed line.

11. The asymmetric wide-angle radar module according to claim 5, wherein when the thickness of the first length of the 1-1 feed line in the direction to the branch point is different from the thickness of the first length of the 1-2 feed line in the direction to the branch point and the L is 2, the power level of the feed signal supplied to the 1-1 feed line becomes different from that of the feed signal supplied to the 1-2 feed line.

12. The asymmetric wide-angle radar module according to claim 11, wherein the thickness of the first length placed in the direction to the branch point in the first feed unit can be adjusted to achieve the impedance match.

13. The asymmetric wide-angle radar module according to claim 5, wherein:
the L is 3 or more, and only one first array antenna is placed at the other end of the 1-1 feed line;
the 1-2 feeding line comprises the 1-2-1 feed line lying between the branch point and the first array antenna disposed closest to the branch point on its right; and
when the thickness of the first length of the 1-1 feed line in the direction to the branch point is different from that of the first length of the 1-2-1 feed line in the direction to the branch point, the power level of the feed signal supplied to the 1-1 feed line becomes different from that of the feed signal supplied to the 1-2-1 feed line.

14. The asymmetric wide-angle radar module according to claim 13, wherein:
the 1-2 feed line further comprises the K-1 1-2-2 feed lines lying between K (K: a positive integer) first array antennas disposed on the right of the first array antenna which is closest to the branch point;
the power level of the feed signal supplied to each of the K-1 1-2-2 feed lines is determined using the thickness of the feed line connected to the input end of the first array antenna in the direction to the branch point on the relevant 1-2-2 feed line and the thickness of the first length on the right of the feed line connected to the input end of the first array antenna on the relevant 1-2-2 feed lines.

15. The asymmetric wide-angle radar module according to claim 10, wherein the first length is λ/4.

16. The asymmetric wide-angle radar module according to claim 1, wherein when the first antenna unit is a transmission channel antenna unit, the second antenna unit becomes a reception channel antenna unit.

17. The asymmetric wide-angle radar module according to claim 1, wherein when the first antenna unit is a reception channel antenna unit, the second antenna unit becomes a transmission channel antenna unit.

18.-22. (canceled)

23. The asymmetric wide-angle radar module according to claim 11, wherein the first length is λ/4.

24. The asymmetric wide-angle radar module according to claim 12, wherein the first length is λ/4.

25. The asymmetric wide-angle radar module according to claim 13, wherein the first length is λ/4.
